(19) United States
(12) Patent Application Publication
(10) Pub. No.: US 2010/0219555 A1
(43) Pub. Date: Sep. 2, 2010

(54) Method for extrusion of multi-layer coated elongate member

(75) Inventor: Ashok K. Mehan, Union City, CA (US)

Correspondence Address: Tyco Electronics Corporation, 309 Constitution Drive, Mail Stop R34/2A, Menlo Park, CA, 94025, US

(73) Assignee: Tyco Electronics Corporation, Berwyn, PA (US)

(21) Appl. No.: 12/380,516

(22) Filed: Feb. 27, 2009

(51) Int. Cl. B29C 47/06

(52) U.S. Cl. 264/173.12

(57) ABSTRACT

A method of making a multi-layer insulated elongate member is disclosed. The method includes providing an elongate member and tube extruding a first thermoplastic material onto an outer surface of the elongate member to create a first layer having a thickness less than or equal to 0.064 mm (0.0025 inch) using a first extruder apparatus. The method further includes using a second extruder apparatus for pressure extruding a compound comprising a second thermoplastic material different from the first thermoplastic material onto an outer surface of the first layer to create a second layer. The second layer fully wets the first layer and the flow point of the first thermoplastic material is at least 30° C. greater than the extrusion melt temperature of the second thermoplastic material.

### RELATED APPLICATIONS

This application is related to U.S. application No. ______ entitled “Multi-Layered Insulated Conductor with Crosslinked Outer Layer” (attorney docket no. E-AD-00019-US) and U.S. application No. ______ also entitled “Multi-Layered Insulated Conductor with Crosslinked Outer Layer” (attorney docket no. E-AD-00020-US), both filed on even date herewith, the disclosures of which are incorporated herein by reference.

### FIELD

This application is directed to a method of manufacturing a multi-layer insulated electrical conductor and more particularly to a method of making a multi-layer insulated conductor using an extrusion process that includes a combination of tube and pressure extruding techniques.

### BACKGROUND

In insulated wire manufacturing, the technique of pressure extruding an insulating material over an elongate member is well known for extruding material directly onto a conductor. Pressure extrusion is a preferred technique for applying thin coatings over an elongate member because tube extrusion techniques tend to result in small holes or cause the layer to break away entirely due to a lack of strength in the thin melt. Pressure extrusion also imparts a smooth surface texture, duplicating the smoothness of the metal surface of the die through which it flows. However, due to the characteristics of the pressure extrusion process, it has widely been believed that it is not possible to pressure extrude a layer of a second insulating material atop an underlying tube extruded first layer, particularly when those layers are very thin (less than 0.064 mm (0.0025 inch) in thickness).

Pressure extrusion techniques demand a very precise, consistent diameter of the member being coated to be able to pass through a closely fitting opening in the guider tip to stop the melt from leaking back through the clearance gap, as well as to improve insulation concentricity. The initial “string-up” phase of manufacturing can be quite difficult to achieve when attempting to apply a layer by pressure extruding over an already coated conductor in which the underlying layer was applied with tube extruding techniques, especially when the tube extruded layer is thin. Shear stresses tend to tear apart the tube extruded layer, resulting in a build up of material behind the die, eventually causing the coated member to jam in the die, typically resulting in breakage. However, in many wire coating applications, tube extrusion is desirable for applying the first insulating layer because a tube extruded first layer usually does not result in an intimate contact with the conductor, which is useful for ease in later stripping of the wires, especially for multi-stranded conductors where the pressure extrusion may force extruded material between the strands.

As a result of this non-intimate contact, pressure extruding over a tube-extruded layer tends to result in the second layer material milking backwards (i.e., slipping against the direction of flow of the conductor) through the guider tip of the pressure extruder that eventually results in a back-up, causing a line break or other failure.

While it is usually desirable to avoid intimate contact between the conductor and the first layer of insulation for ease in stripping, it is also usually desired that when a multi-layer insulation system is employed, that intimate contact or a bond be achieved between subsequent insulation layers.

That is, tube extrusion would be preferred for applying the first insulating layer to a conductor, while pressure extrusion would be preferred for applying one or more intermediate or outer layers over the first insulating layer. However, the apparent incompatibilities between these two techniques have previously prevented such a process from being accomplished when the layers are very thin.

### SUMMARY

According to exemplary embodiments of the invention, the inventors have determined that pressure extrusion can be used for applying an insulating material over an underlying tube-extruded insulating material, even where the tube-extruded insulating material is applied to a thickness of less than 0.064 mm (0.0025 inch).

According to an exemplary embodiment of the invention, a method of making a multi-layer elongate coated member comprises providing an elongate member, thereafter tube extruding a compound comprising a first thermoplastic material onto an outer surface of the elongate member to create a first layer having a thickness less than about 0.064 mm (0.0025 inch) using a first extruder apparatus, and thereafter pressure extruding a compound comprising a second thermoplastic material different from the first thermoplastic material onto an outer surface of the first layer to create a second layer adjacent the first layer using a second extruder apparatus. The second layer fully wets the first layer and the flow point of the first thermoplastic material is at least 30° C. greater than the extrusion melt temperature of the second thermoplastic material.

In one embodiment, the method further includes extruding a third thermoplastic material different from the second thermoplastic material onto an outer surface of the second layer in order to create a third layer having a substantially uniform thickness along its length overlying and in contact with the second layer.

According to another exemplary embodiment of the invention, a method for extruding a multi-layer insulated elongate member comprises providing a tube extruder apparatus having a tube extruder die and a tube extruder guider tip positioned within the tube extruder die, providing a pressure extruder apparatus having a pressure extruder die and a pressure extruder guider tip positioned within the pressure extruder die, the pressure extruder guider tip defining a pressure extruder guider tip opening, drawing an elongate member through the tube extruder guider tip to tube extrude a first insulating layer of a first thermoplastic material onto an outer surface of the conductor to a first insulating layer thickness of about 0.051 mm (0.002 inch), drawing the conductor through the pressure extruder guider tip of the pressure extruder die to pressure extrude a second insulating layer of a second thermoplastic material different from the first thermoplastic material onto an outer surface of the first insulating layer to a second insulating layer thickness of about 0.038 mm (0.0015 inch); and thereafter extruding a third insulating layer of a third thermoplastic material onto an outer surface of the second insulating layer. The second insulating layer fully wets the first insulating layer and the flow point of the first thermoplastic material is at least 30° C. greater than the extrusion melt temperature of the second thermoplastic material. The tensile modulus of the first thermoplastic material is greater than 1241 MPa (180,000 psi) at 25° C. and the tensile modulus of the second thermoplastic material is greater than 1379 MPa (200,000 psi) at 25° C.

An advantage of exemplary embodiments of the invention includes the ability to pressure extrude a thin layer of a material over a thin layer of another material that was previously applied by tube extrusion.

An advantage of certain exemplary embodiments of the invention includes the ability to combine a tube extrusion and a pressure extrusion step in an inline process and thus without the need to have two separate set-ups and two separate coating operations.

Another advantage of certain exemplary embodiments of the invention includes that by applying the layers in an inline process and before sufficient cooling takes place, a better bond can be achieved between the insulating layers while retaining a satisfactory balance of properties in the overall coated product.

Other features and advantages of the present invention will be apparent from the following more detailed description of exemplary embodiments, taken in conjunction with the accompanying drawings which illustrate, by way of example, the principles of the invention.

### BRIEF DESCRIPTION OF THE DRAWINGS

FIG. 1 schematically illustrates an inline extrusion setup for carrying out a method in accordance with an exemplary embodiment of the invention.

FIG. 2 illustrates a cross-section of a two layer insulated conductor formed in accordance with an exemplary embodiment of the invention.

FIG. 3 schematically illustrates an inline extrusion setup for carrying out a method in accordance with another exemplary embodiment of the invention.

FIG. 4 illustrates a cross-section of a three layer insulated conductor formed in accordance with an exemplary embodiment of the invention.

Where like parts appear in more than one drawing, it has been attempted to use like reference numerals for clarity.

### DETAILED DESCRIPTION OF EXEMPLARY EMBODIMENTS

Exemplary embodiments of the invention are directed to methods of coating an elongate member, such as forming an insulated conductor, by extrusion in which an underlying layer of a coating material is applied by tube extrusion and in which a second layer is applied directly over the underlying layer by pressure extrusion. While illustrated primarily with respect to an inline setup, it will be appreciated that the principles of the invention apply equally to processes that include intermediate winding and stringing operations. That is, exemplary embodiments of the invention contemplate both inline extrusion processes and processes in which the coating materials are applied in separate, discrete extrusion steps.

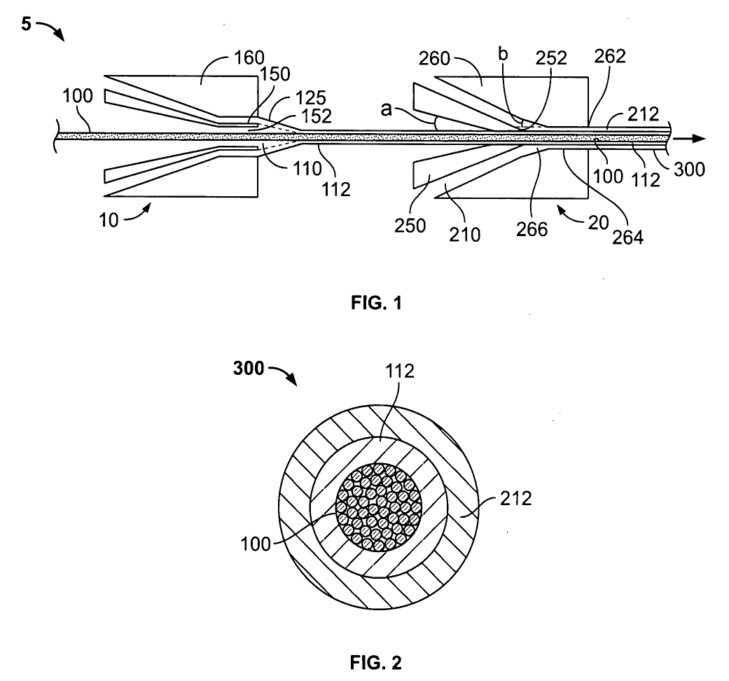

Turning to FIG. 1, an inline extrusion setup 5 is shown schematically that includes a tube extruder apparatus 10 and a pressure extruder apparatus 20 through which an elongate member 100 is drawn and during which multiple layers of a coating material are extruded onto the elongate member 100.

The elongate member 100 may be a wire of any suitable gauge and may be solid or stranded (i.e., made up of many smaller wires twisted together). FIG. 2 illustrates a cross-sectional view of an insulated conductor 300 using the setup illustrated in FIG. 1 according to an exemplary embodiment, in which the elongate member 100 is a stranded conductor. Stranded conductors are preferred for applications in aircraft or other settings in which the conductor will be subject to vibration. The conductor is generally copper or another metal, such as copper alloy or aluminum. If pure copper is used, it may be coated with tin, silver, nickel or other metal to reduce oxidation and improve solderability. Stranded conductors may be of the unilay, concentric or other type. The conductor preferably has a diameter in the range from about 0.40 mm (0.0159 inch) to about 0.81 mm (0.032 inch) for solid conductors, or a diameter in the range from about 0.46 mm (0.0180 inch) to about 1.04 mm (0.041 inch) for stranded conductors. These diameters correspond to standard dimensions for 20 AWG to 26 AWG wires.

A first layer 112 is applied to overlie an outer surface of the conductor 100. The first layer 112 comprises an extrudable thermoplastic material 110 so as to provide a first layer 112 that has a substantially uniform thickness along its length, which cannot adequately be achieved by tape-wrapping techniques. For wire coating applications, the material 110 selected for the first layer 112, also referred to as the inner or core layer, is generally an insulating material and is typically selected to have a high tensile modulus (as measured according to ASTM D638) both at room temperature and at elevated temperature. The tensile modulus of the first layer material should be at least 1241 MPa (180,000 psi) at 25° C. for a coating up to 0.064 mm (0.0025 inch) thick. For coatings equal to or less than about 0.038 mm (0.0015 inch), the tensile modulus should be at least 1379 MPa (200,000 psi) at 25° C., while the tensile modulus for a coating of about 0.025 mm (0.001 inch) should be at least 1724 MPa (250,000 psi) at 25° C.

Furthermore, the first layer material is generally selected to resist bonding with the underlying conductor 100. Bonding to the conductor can increase the difficulty of subsequent stripping. Exemplary suitable materials for use as the first layer material include polyamides, polyesters, polyolefins, such as polymethylpentene for example, polyetheretherketone (PEEK), polyetherketoneketone (PEKK), polyetherketone (PEK), polyimides (PI), polyetherimide (PEI), polyamide-imide (PAI), polysulfone (PS), and polyethersulfone (PES) as well as miscible blends of these materials.

According to an exemplary embodiment of the invention, the first layer 112 is formed by tube extruding in which the conductor 100 is drawn through a guider tip 150 positioned within a tube extrusion die 160 of the tube extruder apparatus 10 that contains bulk melted first layer material 110.

As those of ordinary skill will appreciate, tube extruding involves a melt of the insulating material being extruded as a molten tube in which the melt is brought into physical contact with the surface on which it will be applied (e.g., the outer surface of the conductor 100) after that surface has passed outside of the die 160. With respect to FIG. 1, the conductor 100 passes through the guider tip 150 within the tube extruder apparatus 10 and is contacted with the first layer material 110 as the conductor 100 exits the die 160. Drawing down the ensuing melt tube over the conductor 100 outside the die 160 in the shape of a converging cone 125 results in the forming of the first insulating layer 112 over the conductor 100.

The first layer material 110 should be capable of being drawn down to thinner than the desired wall thickness without breaking away from the conductor or causing significant variation in smoothness of the first layer 112. This permits the conductor 100 coated with the first layer 112 to pass through a closely fitting opening 252 of a guider tip 250 of the second (pressure) extruder 20 during start-up and subsequent ramp-up to steady state operation. That is, the tube extrusion step should be conducted such that the cone 125 does not get too short as to cause a break away or get too long as to cause a lump or an oversized section as the conductor is pulled from the tube extruder 10 to the pressure extruder 20, which may depend upon the particular materials employed for the layer 112 being tube extruded. As a result, for inline operations it may be desirable to first conduct routine experimentation to study the area draw ratio to determine a range of stable cone lengths so that the operating cone length can be better maintained within that range during unsteady state operation, such as manufacturing start-up.

In one embodiment, the conductor 100 and the overlying first layer 112 are drawn from the tube extruder apparatus 10 immediately to the pressure extruder apparatus 20 such that a second thermoplastic material 210 can be pressure extruded to form a second layer 212 over the first layer 112. The use of an inline process according to this exemplary embodiment permits the pressure extruded second layer 212 to be applied over the tube extruded first layer 112 before the first layer 112 has a substantial opportunity to cool. This may enhance bonding between the first and second layers 112, 212. Like the first insulating layer 112, the second layer 212 is also produced to have a substantially uniform thickness, and thus a smooth surface.

As will be appreciated, in pressure extrusion a well prepared (i.e., substantially uniform) melt comes into physical contact with the surface to which it is being applied (here the outer surface of the first layer 112) within the pressure extruder die 260 and are pulled together through the die 260 under pressure.

In accordance with exemplary embodiments, the melt in the pressure extruder 20 generally cannot escape back through the opening from which the conductor 100 is entering the gum space 266 (i.e. at the guider tip opening 252) because the guider tip opening 252 of the pressure extruder 260 is typically shaped and sized to closely match that of the conductor 100 and overlying first layer 112 being pulled through it. More particularly, to avoid any potential problems with back flow through that gap, the opening 252 of the pressure extruder guider tip 250 should be only about 0.0051 mm to 0.025 mm (0.0002 inch to 0.001 inch) larger in diameter than the outer diameter of the first layer 112 moving through it. That is, the diameter of the opening 252 of the pressure extruder guider tip 250 should be only about 0.0051 mm to 0.025 mm (0.0002 inch to 0.001 inch) larger in diameter than the diameter of the coated wire leaving the tube extruder. The conductor's forward movement drags out any melt that would otherwise tend to escape through the gap at the guider tip opening 252. In some applications, the angle of the guider tip opening half angle (shown as angle a in FIG. 1) is between about 15 to 22 degrees, or less, while the half angle of the die opening (shown as angle b in FIG. 1) may be about 25 to 30 degrees. The length of the die land 264 is generally selected to be equal to or less than twice the dimension of the die opening 262, and preferably is equal to the dimension of the die opening.

The pressure extruded second layer 212 can be any thermoplastic material 210 that is different from the thermoplastic material 110 of the tube extruded first layer 112, provided both that the second layer material 210 wets the first layer 112 to achieve intimate contact between the two layers 112, 212 and that the thermoplastic material 110 of the first layer 112 has a flow temperature of at least 30° C. higher than the extrusion melt temperature of the thermoplastic material 210 of the second layer 212. The second layer material 210 can be different in any aspect that might warrant the use of a second layer in addition to a first layer to achieve a desired blend of properties in the overall insulation coating (e.g., to incorporate different additives, crosslinking agents, pigments, etc.) but generally involves the use of a polymeric material that has a different composition than the polymeric material of the first layer. Exemplary second layer materials include fluoropolymers, polyamides, polyesters, polyolefins, or a miscible blend of these materials. In one embodiment, the second insulating layer includes a fluoropolymer selected from the group consisting of poly(ethylene tetrafluoroethylene) (ETFE), poly(ethylene chlorotrifluoroethylene) (ECTFE), polyvinylidene fluoride (PVDF), tetrafluoroethylene-hexafluoropropylene-vinylidene fluoride terpolymer (THV), and miscible blends of these materials. Other suitable fluoropolymers include perfluroalkoxy polymers (PFA) and fluorinated ethylene propylene polymers (FEP).

It will be appreciated that the material selected for the second layer should be chemically compatible with the material of the first layer at the melt processing temperature of the second layer so that the second material can fully wet the first layer material when heated to the extrusion melt temperature of the second layer. By this is meant that sufficiently intimate contact is achieved between the two layers 112, 212 such that the second layer material 210 exerts a sufficiently small backwards drag on the first layer 112 as it passes through the gum space of the pressure extruder die 260 to overcome the tendency of the tube-extruded first layer 112 to back-up in the pressure extruder guider tip 250. In addition, the intimate contact between the two layers may result in a more satisfactory mechanical bond between them, which is generally beneficial for the overall balance of mechanical properties of the total insulation system.

It will further be appreciated that the particular material for the second layer may depend on whether or not a third layer is to be applied over the second layer. That is, the composition used may further depend on whether the second layer is to be an outer layer for the insulated conductor or whether it is provided as an intermediate/tie layer between the core layer and an outer layer.

During the pressure extruding step, the partially insulated conductor (having exited the tube extruding step coated with the first layer 112) should be physically strong enough to tolerate high deforming tensile and shear forces induced in the gum-space 266 and die land 264 of the pressure extruder die 260. Furthermore, if the conductor were to break for any reason, like at a welded joint or because of a flaw during its manufacturing, the conductor must be re-strung through the tightly fitting guider tip opening 252, as well as the gum-space 266 and the die land 264, both full of viscous melt.

As a result, it is important to maintain a high degree of mechanical integrity in the first layer 112 at the intended extrusion melt temperature of the second layer 212. In this regard, the flow point of the first layer material 110 should be at least about 30° C. higher than that of the extrusion melt temperature in the pressure extruder 20. As will be appreciated, by “flow point” is meant the crystalline melting point of the first layer material for a crystalline polymer or the glass transition temperature for an amorphous polymer.

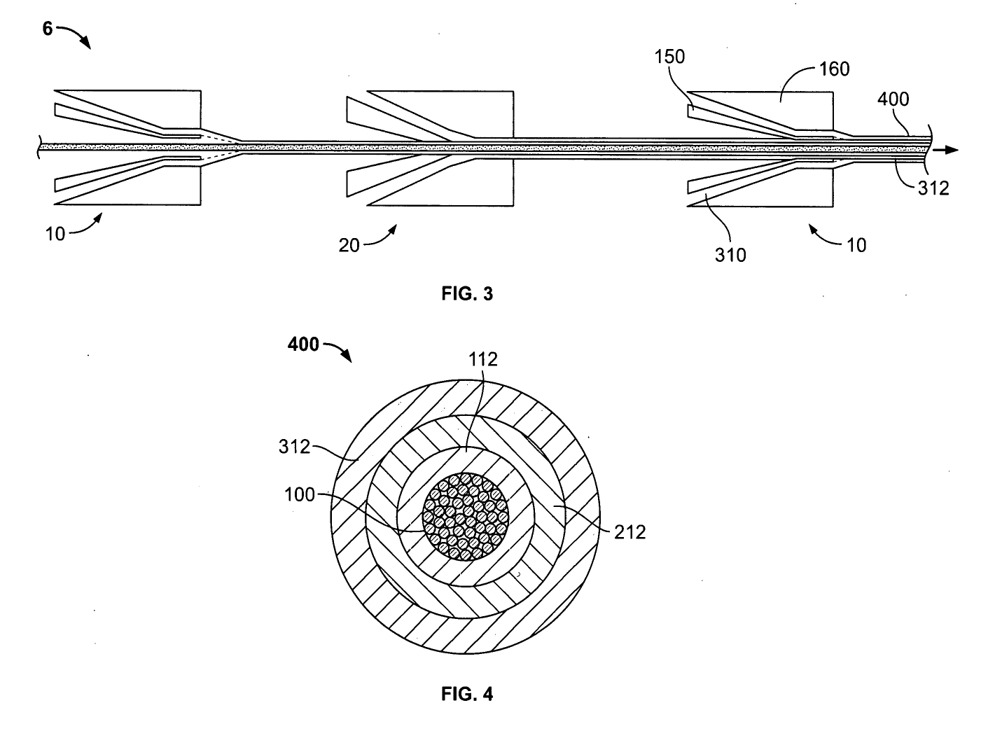

Turning to FIG. 3, according to a preferred embodiment of the invention, an inline system 6 for producing a three layer coated member is illustrated schematically, for example, for use when the second layer 212 is an intermediate layer over which a third layer 312 is applied to create a three layer insulated conductor 400 (FIG. 4). The third layer may be applied by either tube or pressure extruding. As illustrated in FIG. 3, the third layer is applied by tube extrusion, in which a second tube extruder apparatus 10 may be provided as a third inline extruder. If the third layer is applied by pressure extrusion, a second pressure extruder apparatus may be provided as the third inline extruder. Alternatively, the pressure extruder apparatus 20 may be a coextrusion apparatus for simultaneously applying two layers in accordance with coextrusion principles as will be understood by those of ordinary skill in the art.

The third layer may comprise any suitable material for the particular type of extrusion to be used and is different from the second insulating material 210. The third layer insulating material may be the same or different as the first insulating material 110. Where a third layer is applied, the tensile modulus of the second insulating material should be at least 1379 MPa (200,000 psi) at 25° C.

In one embodiment, up to a five layer insulated conductor or more may be produced by applying two additional layers over the third layer 312. For example, it may be desirable to form a 0.025 mm (0.001 inch) thick tube extruded first layer, followed by a 0.19 mm (0.0075 inch) thick pressure extruded second layer, a 0.025 mm (0.001 inch) thick tube extruded third layer, a 0.19 mm (0.0075 inch) thick pressure extruded fourth layer, followed by a 0.076 mm (0.003 inch) thick tube extruded outer layer using two, three, four or even five different materials to produce an overall insulation system for a particular balance of properties.

In addition to the polymeric constituents of the various layers, each of the layers may include any conventional constituents for wire insulation such as antioxidants, UV stabilizers, pigments or other coloring or opacifying agents, and/or flame retardants. Some layers, particularly the outer layer, may also include crosslinking agents. A crosslinking step, such as exposing the coated conductor to a radiation source may be performed to enhance the toughness of the outer layer of the conductor. Any additives, including crosslinking agents, may together make up less than about 20% by weight of the layer, and preferably are about 10% or less by weight.

Thus, the inventors have found that contrary to expectations within the field, that an elongate conductor can be provided with a multi-layer insulating coating by pressure extruding a layer of insulating material over a layer of material that had been applied by tube extrusion, even where the thicknesses of the two layers is very thin, i.e., less than 0.064 mm (0.0025 inch) each.

It will further be appreciated that in carrying out the exemplary methods described herein, it may be desirable to incorporate auxiliary down-line monitoring and take-off equipment as part of the manufacturing set up. This can help reduce problems that may occur during line start-up and/or during re-stringing operations in the event the line is halted, such as when performing a conductor reel change or having to deal with a large insulation fault (e.g., drooling, breakaway, or blistering), for example.

While primarily described with respect to coating an elongate member which is a solid or stranded conductor, it will be appreciated that the foregoing methods can be used in any coating applications and that the teachings herein can be extended to any elongate member for which it may be desirable to apply a layer of material by pressure extrusion over a layer of material applied by tube extrusion. For example, the elongate member may be a conductor with one or more layers of insulation already applied or a multi-conductor cable with more than one insulated or noninsulated conductors, twisted or laid in parallel, with or without a braided or wrapped shield and with or without an outer jacket.

### EXAMPLES

The invention is further described with respect to the following examples, which are presented by way of illustration and not of limitation.

A 20 AWG unilay stranded conductor having an outer diameter of 0.94 mm (0.0372 inch) of soft annealed copper was tin plated. Polyimide, obtained as AURUM from Mitsui Chemicals was tube extruded over the conductor using a Malifer type guider tip having an inner diameter of 5.3 mm (0.210 inch). The tube extruder die head had an opening of 7.5 mm (0.295 inch). The polyimide was tube extruded over the conductor using an extruder barrel length to inside diameter (L/D) ratio of 24:1 to a targeted thickness of 0.051 mm (0.002 inch), producing a coated wire having a diameter of about 1.04 mm (0.041 inch).

The polyimide coated conductor was wound and then strung in a second pass through a pressure extruder, in which a layer of THV obtained as 510 ESD from Dyneon was applied over the previously tube-extruded polyimide coated conductor. The pressure extruder used a Malifer type guider tip having an inner diameter of 1.1 mm (0.042 inch), i.e., 0.025 mm (0.001 inch) larger than the coated conductor pulled therethrough, and a die opening of 1.12 mm (0.044 inch). The THV was successfully pressure extruded over the tube-extruded polyimide coated conductor using an extruder barrel length to inside diameter (L/D) ratio of 24:1 to a thickness of 0.051 mm (0.002 inch), producing a coated wire having a diameter of about 1.15 mm (0.0454 inch). Although done in two passes, this experiment demonstrates the ability of a thin pressure extruded layer to be applied over a thin tube extruded layer, and thus the ability to conduct the same in an inline arrangement for efficiency in manufacturing.

A third layer was then tube extruded over the pressure extruded THV layer. A perfluroalkoxy polymer (PFA) obtained as PFA 450 from Ausimont was used for the third layer. For this layer, a standard guider tip was used having an inner diameter of 6.1 mm (0.240 inch) with a die opening of 8.1 mm (0.320 inch) to apply the PFA to a thickness of about 0.10 mm (0.004 inch). This produced a final specimen that was a three layer insulated conductor having a total insulating thickness of 0.20 mm (0.008 inch), for a total conductor diameter of 1.36 mm (0.0535 inch).

A second example was performed in an identical manner, except that the particular THV (510 ESD) was substituted with a different grade (THV 500) also obtained from Dyneon. This material was pressured extruded to a layer thickness of 0.025 mm (0.001 inch), further demonstrating the ability to successfully pressure extrude thin layers over a thin layer of tube extruded material.

A third example was attempted using a 20 AWG stranded conductor that had been tube-extruded with 0.10 mm (0.004 inch) of polyethylene tetrafluoroethylene (ETFE) prior to coating with THV. The ETFE coated conductor was strung through a pressure extruder having a Malifer type guider tip having an inner diameter of 1.19 mm (0.0470 inch), 0.038 mm (0.0015 inch) larger than that of the diameter of the ETFE coated wire, using a die opening of 1.24 mm (0.0490 inch), with an effort to produce a coated wire having a total diameter of 1.16 mm (0.0455 inch). However, no sample was ultimately made of this particular construction, as the ETFE inner layer demonstrated backup in the guider tip of the pressure extruder, causing the wire to break.

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of making a multi-layer coated elongate member comprising:
providing an elongate member; thereafter
tube extruding a compound comprising a first thermoplastic material onto an outer surface of the elongate member to create a first layer having a thickness less than about 0.064 mm (0.0025 inch) using a first extruder apparatus; and thereafter
pressure extruding a compound comprising a second thermoplastic material different from the first thermoplastic material onto an outer surface of the first layer to create a second layer adjacent the first layer using a second extruder apparatus,
the second layer fully wetting the first layer, and the flow point of the first thermoplastic material being at least 30° C. greater than the extrusion melt temperature of the second thermoplastic material.

2. The method of claim 1, further comprising extruding a compound comprising a third thermoplastic material different from the second thermoplastic material onto an outer surface of the second layer to create a third layer adjacent the second layer.

3. The method of claim 2, wherein the first thermoplastic material is different from the third thermoplastic material.

4. The method of claim 2, comprising tube extruding the third thermoplastic material onto the outer surface of the second layer.

5. The method of claim 2, comprising pressure extruding the third thermoplastic material onto the outer surface of the second layer.

6. The method of claim 5, comprising simultaneously co-extruding the second and third layers.

7. The method of claim 1, wherein the step of pressure extruding is in-line with the step of tube extruding.

8. The method of claim 1, wherein the first thermoplastic material has a tensile modulus of greater than 1241 MPa (180,000 psi) at 25° C.

9. The method of claim 1, comprising tube extruding the first thermoplastic material to form a first layer having a thicknesses of equal to or less than about 0.025 mm (0.001 inch).

10. The method of claim 9, wherein the first thermoplastic material has a tensile modulus of greater than 1724 MPa (250,000 psi) at 25° C.

11. The method of claim 9, comprising pressure extruding the second thermoplastic material to form a second layer having a thickness of equal to or less than about 0.038 mm (0.0015 inch).

12. The method of claim 1, wherein the steps of tube extruding and pressure extruding form an insulated elongate member having a total thickness of the first and second layers of less than 0.076 mm (0.003 inch).

13. The method of claim 1, wherein the elongate member is a stranded conductor having a diameter in the range of about 0.46 mm (0.0180 inch) to about 1.04 mm (0.041 inch).

14. The method of claim 1, wherein the first layer is bonded to the second layer.

15. A method of making a multi-layer coated elongate member comprising:
providing a tube extruder apparatus having a tube extruder die and a tube extruder guider tip positioned within the tube extruder die;
providing a pressure extruder apparatus having a pressure extruder die and a pressure extruder guider tip positioned within the pressure extruder die, the pressure extruder guider tip defining a pressure extruder guider tip opening;
drawing an elongate member through the tube extruder guider tip to tube extrude a first insulating layer of a first thermoplastic material onto an outer surface of the elongate member to a first insulating layer thickness of less than or equal to 0.051 mm (0.002 inch);
drawing the elongate member through the pressure extruder guider tip of the pressure extruder die to pressure extrude a second insulating layer of a second thermoplastic material different from the first thermoplastic material onto an outer surface of the first insulating layer to a second insulating layer thickness of less than or equal to 0.038 mm (0.0015 inch); and
extruding a third insulating layer of a third thermoplastic material onto an outer surface of the second insulating layer;
wherein the second insulating layer fully wets the first insulating layer,
wherein the flow point of the first thermoplastic material is at least 30° C. greater than the extrusion melt temperature of the second thermoplastic material, and
wherein the tensile modulus of the first thermoplastic material is greater than 1241 MPa (180,000 psi) at 25° C. and the tensile modulus of the second thermoplastic material is greater than 1379 MPa (200,000 psi) at 25° C.

16. The method of claim 15, wherein the step of pressure extruding the second insulating layer is in-line with the step of tube extruding the first insulating layer.

17. The method of claim 16, wherein the method further comprises
providing a second tube extruder apparatus in line with the pressure extruder apparatus, the second tube extruder having a second tube extruder die and a second tube extruder guider tip positioned within the die; and
immediately after the step of drawing the elongate member through the pressure extruder die, drawing the elongate member through the second tube extruder guider tip of the second tube extruder die to tube extrude the third insulating layer onto the outer surface of the second insulating layer.

18. The method of claim 15, wherein the elongate member is a stranded conductor having a diameter in the range of about 0.46 mm (0.0180 inch) to about 1.04 mm (0.041 inch).

19. The method of claim 15, further comprising crosslinking the third insulating layer.

20. The method of claim 15, wherein the second insulating layer is bonded to the first insulating layer.
